(19) United States
(12) Patent Application Publication
(10) Pub. No.: US 2025/0103856 A1
(43) Pub. Date: Mar. 27, 2025

(54) LOCAL CROSS-ATTENTION OPERATIONS IN NEURAL NETWORKS

(71) Applicant: DeepMind Technologies Limited, London (GB)

(72) Inventors: Joao Carreira, St. Albans (GB); Andrew Coulter Jaegle, London (GB); Skanda Kumar Koppula, London (GB); Daniel Zoran, London (GB); Adrià Recasens Continente, London (GB); Catalin-Dumitru Ionescu, London (GB); Olivier Jean Hénaff, London (GB); Evan Gerard Shelhamer, London (GB); Relja Arandjelovic, Munich (DE); Matthew Botvinick, Philadelphia, PA (US); Oriol Vinyals, London (GB); Karen Simonyan, London (GB); Andrew Zisserman, London (GB)

(21) Appl. No.: 18/832,817

(22) PCT Filed: Jan. 30, 2023
(86) PCT No.: PCT/EP2023/052183

§ 371 Date: Jul. 24, 2024

Related U.S. Application Data
(60) Provisional application No. 63/304,316, filed on Jan. 28, 2022.

(51) Int. Cl. G06N 3/045

(52) U.S. Cl. CPC G06N 3/045

(57) ABSTRACT

Methods, systems, and apparatus, including computer programs encoded on a computer storage medium, for using a neural network to generate a network output that characterizes an entity. In one aspect, a method includes: obtaining a representation of the entity as a set of data element embeddings, obtaining a set of latent embeddings, and processing: (i) the set of data element embeddings, and (ii) the set of latent embeddings, using the neural network to generate the network output. The neural network includes a sequence of neural network blocks including: (i) one or more local cross-attention blocks, and (ii) an output block. Each local cross-attention block partitions the set of latent embeddings and the set of data element embeddings into proper subsets, and updates each proper subset of the set of latent embeddings using attention over only the corresponding proper subset of the set of data element embeddings.

### CROSS-REFERENCE TO RELATED APPLICATIONS

This application claims the benefit of the filing date of U.S. Provisional Patent Application Ser. No. 63/304,316 for “LOCAL CROSS-ATTENTION OPERATIONS IN NEURAL NETWORKS,” which was filed on Jan. 28, 2022, and which is incorporated here by reference in its entirety.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations that uses a neural network to process data element embeddings that represent an entity to generate a network output that characterizes the entity. The neural network can be configured to process data element embeddings that represent any appropriate type of entity. For example, the entity can include an image, an audio waveform, a point cloud (e.g., generated by a lidar or radar sensor), a protein, a sequence of words (e.g., that form one or more sentences or paragraphs), a video (e.g., represented a sequence of video frames), or a combination thereof. The neural network can be configured to generate any appropriate neural network output that characterizes the entity. For example, the neural network output can be a classification output, a regression output, a sequence output (i.e., that includes a sequence of output elements), a segmentation output, or a combination thereof.

According to a first aspect, there is provided a method for using a neural network to generate a network output that characterizes an entity, the method including: obtaining a representation of the entity as a set of data element embeddings, obtaining a set of latent embeddings, and processing: (i) the set of data element embeddings, and (ii) the set of latent embeddings, using the neural network to generate the network output characterizing the entity. The neural network includes a sequence of neural network blocks including: (i) one or more local cross-attention blocks, and (ii) an output block. Each local cross-attention block performs operations including: determining a partition of the set of latent embeddings into a plurality of proper subsets of the set of latent embeddings, determining a partition of the set of data element embeddings into a plurality of proper subsets of the set of data element embeddings, identifying, for each proper subset of latent embeddings, a corresponding proper subset of the data element embeddings, and updating each proper subset of the set of latent embeddings using attention over only the corresponding proper subset of the set of data element embeddings. The output block performs operations including: after the set latent embeddings are updated using the one or more cross-attention blocks, processing one or more latent embeddings from the set of latent embeddings to generate the network output characterizing the entity.

In some implementations, the neural network further includes one or more self-attention blocks, wherein each self-attention block performs operations including: updating the set of latent embeddings using attention over the set of latent embeddings.

In some implementations, the neural network further includes one or more global cross-attention blocks, wherein each global cross-attention block performs operations including: updating the set of latent embeddings using attention over the set of data element embeddings.

In some implementations, for each local cross-attention block, the set of latent embeddings is partitioned into a same number of proper subsets as the set of data element embeddings.

In some implementations, for each local cross-attention block, each proper subset of the latent embeddings corresponds to a different proper subset of the data element embeddings.

In some implementations, the neural network includes a locality-reducing sequence of local cross-attention blocks, where for each local cross-attention block after a first local cross-attention block in the locality-reducing sequence of local cross-attention blocks: the local cross-attention block partitions the set of data element embeddings into a smaller number of proper subsets than a preceding local cross-attention block in the locality-reducing sequence of local cross-attention blocks.

In some implementations, the neural network includes a locality-increasing sequence of local cross-attention blocks, where for each local cross-attention block after a first local cross-attention block in the locality-increasing sequence of local cross-attention blocks: the local cross-attention block partitions the set of data element embeddings into a greater number of proper subsets than a preceding local cross-attention block in the locality-increasing sequence of local cross-attention blocks.

In some implementations, the locality-reducing sequence of local cross-attention blocks precedes the locality-increasing sequence of local cross-attention blocks in the neural network.

In some implementations, the neural network includes one or more global cross-attention blocks between the locality-reducing sequence of local cross-attention blocks and the locality-increasing sequence of local cross-attention blocks.

In some implementations, a number of latent embeddings in the set of latent embeddings is less than a number of data element embeddings in the set of data element embeddings.

In some implementations, a number of latent embeddings in the set of latent embeddings is predefined and independent of a number of data element embeddings in the set of data element embeddings.

In some implementations, the neural network includes multiple local cross-attention blocks and multiple self-attention blocks, and where the local cross-attention blocks and the self-attention blocks are interleaved.

In some implementations, for each local cross-attention block, updating each proper subset of the latent embeddings includes, for each latent embedding in the proper subset of the latent embeddings: determining, for each data element embedding in the corresponding proper subset of the data element embeddings, a respective attention weight for the data element embedding based on: (i) the data element embedding, and (ii) the latent embedding, and updating the latent embedding using: (i) the attention weights, and (ii) the corresponding proper subset of the data element embeddings.

In some implementations, the method further includes; obtaining a set of positional embeddings, where each positional embedding represents a position of a corresponding data element embedding in the representation of the entity, where processing: (i) the set of data element embeddings, and (ii) the set of latent embeddings, using the neural network includes: updating each data element embedding using a respective positional embedding representing the position of the data element embedding.

In some implementations, the method further includes: masking a portion of the representation of the entity before the representation of the entity is provided to the neural network, where the network output includes a reconstruction of the masked portion of the representation of the entity.

In some implementations, the method further includes determining gradients of an error in the reconstruction of the masked portion of the representation of the entity, and updating the set of positional embeddings using the gradients of the error in the reconstruction of the masked portion of the representation of the entity.

In some implementations, the set of data element embeddings comprises at least one million data element embeddings.

In some implementations, the set of data element embeddings represents one or more of: an image, an audio waveform, or a point cloud.

According to a second aspect, there is provided a method for learning positional embeddings, the method including: obtaining a representation of an entity as a set of data element embeddings, obtaining a set of positional embeddings, where each positional embedding represents a position of a corresponding data element embedding in the representation of the entity, masking a portion of the representation of the entity, after masking the portion of the representation of the entity, processing an input including the representation of the entity using a neural network to generate a reconstruction of the masked portion of the representation of the entity, including: updating each data element embedding using a respective positional embedding representing the position of the data element embedding, and processing the updated data element embeddings, by one or more neural network layers of the neural network, to generate the reconstruction of the masked portion of the representation of the entity. The method further includes: determining gradients of an error in the reconstruction of the masked portion of the representation of the entity, and updating the set of positional embeddings using the gradients of the error in the reconstruction of the masked portion of the representation of the entity.

In some implementations, determining gradients of the error in the reconstruction of the masked portion of the representation of the entity includes: backpropagating gradients through the neural network layers of the neural network and into the set of positional embeddings.

In some implementations, updating the set of positional embeddings using the gradients includes: updating the set of positional embeddings using the gradients in accordance with a gradient descent optimization technique.

In some implementations, the method further includes: updating a set of neural network parameter values of the neural network using the gradients of the error in the reconstruction of the masked portion of the representation of the entity.

In some implementations, masking the portion of the representation of the entity includes: selecting a portion of the representation of the entity to be masked, and applying a masking operation to the selected portion of the representation of the entity.

In some implementations, selecting a portion of the representation of the entity to be masked includes: randomly selecting a predefined fraction of the representation of the entity to be masked.

In some implementations, applying a masking operation to the selected portion of the representation of the entity includes: replacing the selected portion of the representation of the entity by default data.

In some implementations, applying the masking operation to the selected portion of the representation of the entity includes: removing the selected portion of the representation of the entity.

According to a third aspect, there is provided a system including: one or more computers, and one or more storage devices communicatively coupled to the one or more computers, where the one or more storage devices store instructions that, when executed by the one or more computers, cause the one or more computers to perform the operations of the respective method of any preceding aspect.

According to a fourth aspect, there are provided one or more non-transitory computer storage media storing instructions that when executed by one or more computers cause the one or more computers to perform the operations of the respective method of any preceding aspect.

The subject matter described in this specification can be implemented in particular embodiments so as to realize one or more of the following advantages.

To generate an output that characterizes an entity (e.g., an image) represented as a set of data element embeddings, the system described herein instantiates a set of latent embeddings, and processes both the data element embeddings and the latent embeddings using a neural network. The system can instantiate a predefined number of latent embeddings that is independent of the number of data element embeddings. As part of processing the data element embeddings and the latent embeddings, the neural network updates the set of latent embeddings using cross-attention over the set of data element embeddings, thereby enriching the latent embeddings with information from the data element embeddings. Because the number of latent embeddings is independent of the number of data element embeddings, the computational complexity of the cross-attention operation is partially decoupled from the number of data element embeddings and can remain feasible even for large numbers of data element embeddings.

To further reduce the computational complexity of the cross-attention operation, the neural network can be configured to perform a “local” cross-attention operation. In particular, the neural network can determine respective partitions of the set of latent embeddings and the set of data element embeddings into proper subsets, and then update each proper subset of the latent embeddings using cross-attention over only a corresponding proper subset of the data element embeddings. A proper subset of elements is a subset comprising less than all the elements. Thus, in contrast to a “global” cross-attention operation where each latent embedding is updated using cross-attention over the entire set of data element embeddings, the local cross-attention operation updates each latent embedding using cross-attention over only a fraction of the data element embeddings.

To enhance information flow from the set of data element embeddings to the set of latent embeddings, the neural network can perform multiple local cross-attention operations with various degrees of localization. For example, the neural network can perform a hierarchy of local cross-attention operations that progressively partition the set of latent embeddings and the set of data element embeddings into fewer subsets. This configuration of the local cross-attention operations can encourage a smooth transition from local to global information flow from the set of data element embeddings to the set of latent embeddings. As another example, the neural network can perform a hierarchy of local cross-attention operations that progressively partition the set of latent embeddings and the set of data element embeddings into more subsets. This configuration of the local cross-attention operations can encourage a smooth transition from global to local information flow from the set of data element embeddings to the set of latent embeddings.

Performing local cross-attention operations can significantly reduce consumption of computational resources (e.g., memory and computing power) by the neural network without significantly diminishing the performance (e.g., prediction accuracy) of the neural network. In particular, performing local cross-attention operations can enable the neural network to scale up to efficiently processing very large numbers of data element embeddings, e.g., millions of data element embeddings, representing high resolution images, video, or audio.

The system described herein can process a set of data element embeddings representing an entity using a neural network that implements attention operations that do not require assuming that the data element embeddings are associated with a fixed spatial arrangement. For example, the attention operations do not rely on assuming that the data element embeddings are associated with a spatial arrangement into a one-dimensional (1D) sequence (e.g., of audio data samples) or a two-dimensional (2D) grid (e.g., of image pixels). Rather, the system can flexibly incorporate information regarding the spatial arrangement of the data element embeddings by tagging (e.g., concatenating) positional embeddings to the data element embeddings, and allowing the attention operations to learn to draw on this information when relevant to generating accurate network outputs. Therefore, the neural network can be used to process sets of data element embeddings that are not associated with a predefined spatial arrangement, e.g., sets of data elements representing point clouds or proteins, thereby making the system more broadly applicable.

However, conventional positional embeddings, e.g., hand-designed Fourier positional embeddings, can require high-dimensional representations, e.g., hundreds of dimensions per data element embedding. Thus the use of conventional positional embeddings can significantly increase consumption of computational resources, particularly when positional embeddings are used in conjunction with large numbers (e.g., millions) of data element embeddings representing high resolution data.

To address this issue, the system can train a set of positional embeddings that encode positional information more compactly and effectively than conventional positional embeddings. In particular, to train a set of positional embeddings, the system can use the positional embeddings to augment a set of data element embeddings that have been partially masked, and which are processed by a neural network that generates a reconstruction of the masked portion of the data element embeddings. Generally, “masking” a part of a dataset can refer to modifying the dataset to remove some or all of the information content represented by the part of the dataset, e.g., by replacing the part of dataset by default (e.g., predefined or random) values, or by removing the part of the dataset. The system can iteratively adjust the positional embeddings to optimize a reconstruction objective function that measures an error in the reconstructions generated by the neural network, e.g., by backpropagating gradients of the objective function into the positional embeddings. The reconstruction objective function provides a rich gradient signal for learning highly informative positional embeddings. The learned positional embeddings can be significantly more compact than conventional positional embeddings and thus enable reduced consumption of computational resources.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example neural network system.

FIG. 2 is a block diagram of the example neural network system in more detail.

FIG. 3 illustrates example sequences of local cross-attention blocks.

FIG. 4 is a flow diagram of an example process for using a neural network system to characterize an entity.

FIG. 5 is a flow diagram of an example process for iteratively training a set of positional embeddings.

FIGS. 6A and 6B illustrate example configurations of a neural network system.

FIG. 7 illustrates an example representation of an entity that has been partially masked by a neural network system.

FIG. 8A, FIG. 8B, and FIG. 8C illustrate example experimental results achieved using the neural network system.

FIG. 9A and FIG. 9B illustrate an example set of positional embeddings before and after training, respectively.

Like reference numbers and designations in the various drawings indicate like elements.

### DETAILED DESCRIPTION

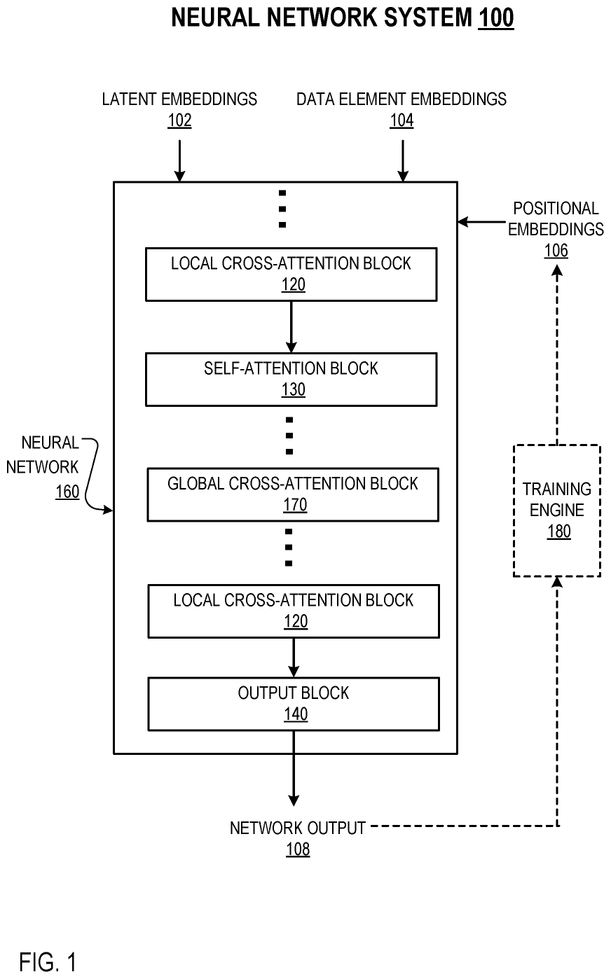

FIG. 1 is a block diagram of an example neural network system 100 that can generate a network output 108 characterizing an entity. The neural network system 100 is an example of a system implemented as computer programs on one or more computers in one or more locations in which the systems, components, and techniques described below are implemented.

Throughout this specification an “entity” can include any appropriate type of data. For example, the entity can include an image, an audio waveform, a point cloud (e.g., generated by a lidar or radar sensor), a protein, a sequence of words (e.g., that form one or more sentences or paragraphs), a video (e.g., represented a sequence of video frames), or any other appropriate type of data or a combination thereof.

In some implementations, the entity can include multiple units arranged in a spatial structure. The spatial structure may correspond to a physical spatial structure (e.g. pixels in an image), or an abstract spatial structure (e.g. a time sequence of audio samples). Each unit, or data element, in the entity can have an associated data element embedding that can characterize, e.g., a position of the unit in the spatial structure and/or features associated with the unit in the spatial structure. Examples of entities and units are described in more detail next.

In one example, the entity can include a still or moving image and each pixel, e.g. an intensity value of each pixel, or region of pixels, in the image can define a respective unit in the entity. In another example, the entity can include an audio waveform and each audio sample in the audio waveform, or e.g. in a mel spectrogram of the audio waveform, can define a respective unit in the entity. In yet another example, the entity can include a point cloud and each point in the point cloud, e.g. the location of each point in 3D space, e.g. in x, y, z coordinates, can define a respective unit in the entity. In yet another example, the entity can include a protein and each amino acid in an amino acid sequence of the protein can define a respective unit in the entity. In yet another example, the entity can include a sequence of words and each word in the sequence of words can define a respective unit in the entity.

The neural network system 100 can be configured to process: (i) a representation of the entity as a set of data element embeddings 104, and (ii) a set of latent embeddings 102 (e.g., initialized randomly, or learned during training), to generate the network output 108 characterizing the entity. The network output 108 can be, e.g., a classification output, a regression output, a sequence output (i.e., that includes a sequence of output elements), a segmentation output, or any other appropriate network output or a combination thereof.

An “embedding” can generally refer to an ordered collection of numerical values, e.g., a vector, matrix, or other tensor of numerical values. A “data element embedding” can refer to an embedding of a data element that is associated with a particular unit in the entity. There are many ways of generating an embedding. For example, a word or wordpiece or amino acid may be mapped to a data element embedding or by a table or neural network. The raw value of a pixel or of a digitized audio waveform may itself be the embedding. A “latent embedding” can refer to an embedding that is predefined and/or randomly initialized in a latent space. Generally, the data element embeddings and the latent embeddings can have any appropriate dimensionality. In some implementations, the dimensionality of the data element embeddings can be different from the dimensionality of the latent embeddings. For example, if the entity is an image having dimensions 224×224 pixels, and the number of data element embeddings is M=50176, then the number of latent embeddings can be, e.g., N=512, such that N<<M.

Generally, the set of data element embeddings 104 can include any appropriate number of data element embeddings, e.g., 1 thousand embeddings, 10 thousand embeddings, 100 thousand embeddings, 500 thousand embeddings, 1 million embeddings, 5 million embeddings, 10 million embeddings, or any other appropriate number of data element embeddings. In some implementations, the number of latent embeddings 102 can be predefined and independent of the number of data element embeddings 104. For example, the value of each entry (or element) of each latent embedding 102 can be sampled, e.g., from a Normal distribution. In some implementations, the number of latent embeddings 102 can be a hyper-parameter of the neural network system 100.

In some cases, the entity can be multimodal, e.g., the entity can include a combination of different types of data, such as image or video data and audio data, image or video data and language data, somatosensory input data (sensor data sensing the real-world environment of a physical agent, such as sensing touch, pressure, movement, temperature or vibration data) and motor feedback data (i.e. control data to control movement of the physical agent). As an example the set of data element embeddings of a multimodal entity may be obtained by concatenating embeddings of the different modes of data. For example, with an audio-visual entity the set of data element embeddings may comprise a concatenation of the raw audio and the pixels, optionally at sampling rates where they generate broadly similar numbers of samples. Where the entity is multimodal, each type, or domain, of data can also be associated with one or more modality-specific features i.e. embeddings. These may be fixed or learned, and because they are modality-specific can be used by the system 100 to identify the modality. Thus, in addition to being represented by the set of data element embeddings 104, the units of the multimodal entity may be tagged with modality-specific features (embeddings).

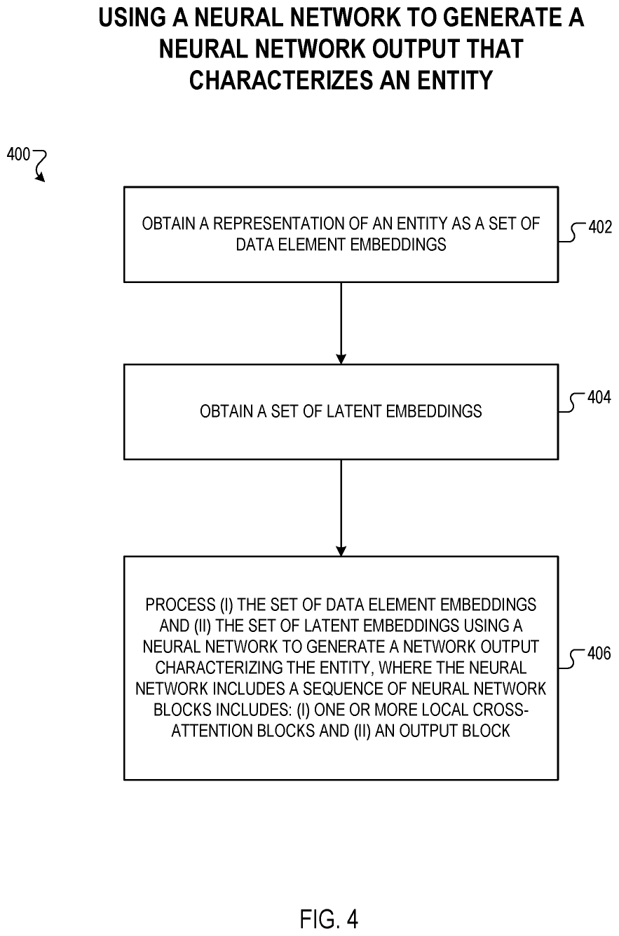

In some cases, as described above, the entity can include, e.g., multiple units arranged in a spatial structure (as a one-dimensional (1D), two-dimensional (2D), or three-dimensional (3D) array of units), where each unit is associated with positional data that defines a respective position of the unit in the spatial structure. The neural network system 100 can incorporate information regarding the spatial arrangement of the data element embeddings by obtaining a set of positional embeddings 106, where each positional embedding represents a position of a corresponding data element embedding 104 in the representation of the entity. In some cases, before processing the data element embeddings, 104 the neural network system 100 can tag (e.g., concatenate) positional embeddings 106 to the data element embeddings 104. Positional embeddings are described in more detail below with reference to FIG. 4.

As described above, the neural network system 100 can be configured to process the data element embeddings 104 and the latent embeddings 102 to generate the network output 108 that characterizes the entity. More specifically, the neural network system 100 can include a neural network 160 having a sequence of one or more neural network blocks. Generally, a neural network “block” refers to a group of one or more neural network layers in a neural network. The sequence of neural network blocks can include: (i) one or more local cross-attention blocks 120, and (ii) an output block 140. For example, the sequence of neural network blocks can include a first local cross-attention block 120, followed by a second local cross-attention block 120, followed by a third local cross-attention block 120, followed by an output block 140. A self-attention block, or cross-attention block, is in general a block that includes an attention mechanism, specifically a self-attention or cross-attention mechanism respectively. There are many different types of attention mechanisms that may be used.

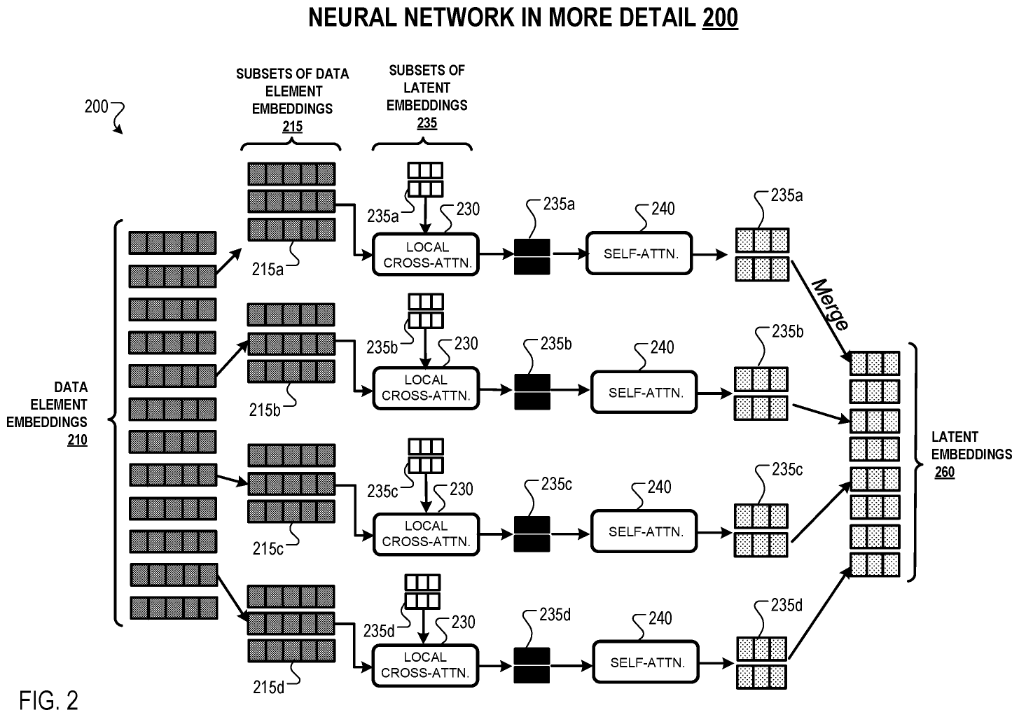

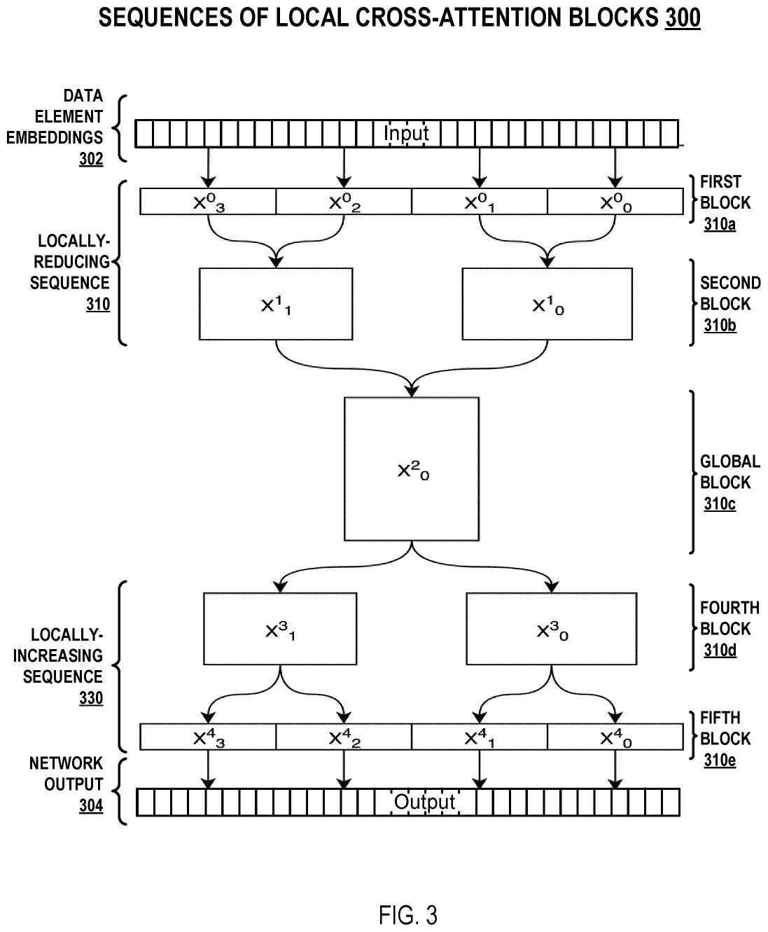

In some cases, the sequence of neural network blocks in the neural network 160 can further include (iii) one or more self-attention blocks 130 and/or (iv) one or more global cross-attention blocks 170. A global cross-attention block can perform a cross-attention operation using the entire set of data element embeddings that are input to the block. For example, as illustrated in FIG. 1, the sequence of neural network blocks can include a first local cross-attention block 120, followed by a self-attention block 130, followed by a global cross-attention block 170, followed by a second local cross-attention block 120, followed by an output block 140. In some implementations, the sequence of encoder blocks can include any number of local cross-attention blocks, global cross-attention blocks, self-attention blocks, and output blocks, arranged in any appropriate configuration. For example, in some cases, the sequence of neural network blocks can include multiple local cross-attention blocks 120 and multiple self-attention blocks 130, where the local cross-attention blocks 120 and the self-attention blocks 130 are interleaved. Example sequences of neural network blocks are described in more detail below with reference to FIG. 2 and FIG. 3. Generally, the neural network 160 can include any number of neural network blocks configured to perform any appropriate operations and arranged in any appropriate configuration.

The neural network system 100 can use the sequence of neural network blocks to process the data element embeddings 104 and the latent embeddings 102 to generate the network output 108 characterizing the entity. As described in more detail below, the attention blocks (e.g., the local cross-attention block 120, the global cross-attention block 170, and the self-attention block 130) can be configured to perform an attention operation, e.g., update each embedding in a first set of embeddings using attention over a second set of embeddings.

In general updating a first set of embeddings using attention over a second set of embeddings refers to updating the first set of embeddings by applying an attention mechanism over the second set of embeddings; there are many different possible attention mechanisms that can be used. For example, for each target embedding in the first set of embeddings, each attention block can generate a respective attention weight for each embedding in the second set of embeddings, and generate a combined embedding based on the second set of embeddings and the corresponding attention weights. As a particular example, each attention block can generate the combined embedding as a weighted sum of the second set of embeddings, e.g., by multiplying each embedding in the second set of embeddings with the corresponding weight and summing the weighted embeddings. Each attention block can then use the combined embedding to update the target embedding in the first set of embeddings, e.g., by replacing the target embedding with the combined embedding, adding the combined embedding to the target embedding, or in any other appropriate manner.

In some implementations, the attention blocks can perform a query-key-value (QKV) attention operation, e.g., update each embedding in the first set of embeddings using attention over the second set of embeddings using query (Q), key (K), and value (V) embeddings. In particular, each attention block can include: (i) a query sub-network, (ii) a key sub-network, and (iii) a value sub-network. For each target embedding in the first set of embeddings, the query sub-network can be configured to process the target embedding in the first set of embeddings to generate a respective query embedding (Q) for the target embedding. The key sub-network can be configured to process each embedding in the second set of embeddings to generate a respective key embedding (K) for each embedding in the second set of embeddings. Similarly, the value sub-network can be configured to process each embedding in the second set of embeddings to generate a respective value embedding (V) for each embedding in the second set of embeddings.

Each attention block can then use the query embeddings (Q), the key embeddings (K), and the value embeddings (V), to update each target embedding in the first set of embeddings over the second set of embeddings. Specifically, each attention block can generate the attention weight for each embedding in the second set of embeddings, e.g., as an inner (e.g., dot) product of the query embedding (Q) with each of the key embeddings (K). Based on the second set of embeddings and the attention weights, each attention block can generate the combined embedding, e.g., as a linear combination of the value embeddings (V) weighted by their respective attention weights. Lastly, each attention block can update the target embedding in the first set of embeddings using the combined embedding, e.g., by replacing the target embedding in the first set of embeddings with the weighted sum of the value embeddings (V).

In some implementations, the first set of embeddings and the second set of embeddings can be the same set of embeddings. In such cases, the attention operation (e.g., the QKV attention operation) can be referred to as a “self-attention” operation. The self-attention operation can be performed by, e.g., the self-attention block 130. For example, the first set of embeddings can be the set of latent embeddings 102, the second set of embeddings can also be the set of latent embeddings, and the self-attention block 130 can update each latent embedding in the set of latent embeddings 102 using self-attention over the set of latent embeddings. In some implementations, the self-attention block 130 can repeatedly update each latent embedding in the set of latent embeddings using self-attention over the set of latent embeddings.

In some implementations, the first set of embeddings and the second set of embeddings can be different sets of embeddings. In such cases, the attention operation (e.g., the QKV attention operation) can be referred to as a “cross-attention” operation. The cross-attention operation can be performed by, e.g., the local cross-attention block 120 and the global cross-attention block 170. For example, the first set of embeddings can be the set of latent embeddings 102, the second set of embeddings can be the set of data element embeddings 104, and the global cross-attention block 170 or the local cross-attention block 120 can update each latent embedding in the set of latent embeddings 102 using cross-attention over the set of data element embeddings 104.

As described above, the local cross-attention block 120 and the global cross-attention block 170 can be configured to perform a cross-attention operation. However, in some cases, the global cross-attention block 170 can be configured to perform a “global” cross-attention operation, while the “local” cross-attention block 120 can be configured to perform a “local” cross-attention operation. A “global” cross-attention operation can refer to a cross-attention operation that is performed using the entire set of latent embeddings 104 and the entire set of data element embeddings 104. That is, the global cross-attention block 170 can be configured to update each latent embedding in the entire set of latent embeddings 102 using cross-attention over the entire set of data element embeddings 104. By contrast, a “local” cross-attention operation can refer to a cross-attention operation that is performed using only a proper subset of the set of latent embeddings 102 and only a proper subset of the set of data element embeddings 104. That is, the local cross-attention block 120 can be configured to update each latent embedding in the proper subset of the set of latent embeddings 102 using cross-attention over only the proper subset of the set of data element embeddings 104.

To perform the local cross-attention operation, e.g., as described above, the local cross-attention block 120 can be configured to determine a partition of the set of latent embeddings 102 into multiple proper subsets. Similarly, the local cross-attention block 120 can be configured to determine a partition of the set of data element embeddings 104 into multiple proper subsets. In some cases, the local cross-attention block 120 can partition the set of latent embeddings 102 into the same number of proper subsets as the set of data element embeddings 104. For example, the local cross-attention block 120 can partition M data element embeddings into G proper subsets, such that each subset includes M/G data element embeddings. Similarly, the local cross-attention block 120 can partition N latent embeddings into G subsets, such that each subset includes N/G latent embeddings. As a particular example, for each set of embeddings, the attention blocks can arrange the embeddings included in the set as an array indexed by an indexing variable (e.g., 1, 2, 3, 4, etc.). The attention blocks can partition the range of the indexing variable into a sequence of non-overlapping intervals (e.g., 1 to 3, 4 to 6, etc.). Then, the attention blocks can assign all the embeddings in the set of embeddings having index values falling within the same non-overlapping interval as belonging to the same proper subset of embeddings.

The local cross-attention block 120 can identify, for each proper subset of the set of latent embeddings 102, a corresponding proper subset of the set of data element embeddings 104. In some cases, each proper subset of the set of latent embeddings 102 can correspond to a different proper subset of the set of data element embeddings 104. For example, for each proper subset of latent embeddings, the local cross-attention block 120 can assign a unique proper subset of data element embeddings, e.g., different from the other proper subsets of data element embeddings.

Then, the local cross-attention block 120 can use the proper subset of latent embeddings and corresponding proper subset of data element embeddings to perform the local cross-attention operation, e.g., to update each latent embedding in the proper subset of latent embeddings using attention over only the corresponding proper subset of data element embeddings. In other words, the local cross-attention block 120 updates each latent embedding in the proper subset of latent embeddings using attention only over the proper subset of data element embeddings that was identified by the local cross-attention block 120 as corresponding to the proper subset of latent embeddings, and not over any other proper subset of data element embeddings.

In some cases, the neural network system 100 can perform multiple local cross-attention operations, e.g., as described above, but with various degrees of localization. For example, the neural network system 100 can perform a hierarchy of local cross-attention operations that progressively partition the set of latent embeddings 102 and the set of data element embeddings 104 into fewer subsets. This configuration of the local cross-attention operations can encourage a smooth transition from local to global information flow from the set of data element embeddings 104 to the set of latent embeddings 102. An example hierarchy of local cross-attention operations is described in more detail below with reference to FIG. 3. Performing local cross-attention operations in a manner as described above can enable the neural network system 100 to scale up to efficiently processing very large numbers of data element embeddings, e.g., millions of data element embeddings, representing entities such as high resolution images, video, and audio.

In some implementations, the local cross-attention block 120, the global cross-attention block 170, and the self-attention block 130 can be configured to perform other operations in addition to the attention operations described above. For example, in addition to implementing one or more attention neural network layers, the attention blocks can also include any other neural network layers (e.g., convolutional layers, fully connected layers, recurrent layers, attention layers, etc.) in any appropriate numbers (e.g., 2 layers, 5 layers, or 10 layers) and connected in any appropriate configuration (e.g., as a linear sequence of layers). In some cases, after performing the attention operations, the attention blocks can be configured to merge the proper subsets of embeddings back into a single set of embeddings, and provide the set of embeddings to the next block (or neural network layer) in the sequence of neural network blocks.

In addition to the attention blocks, the neural network 160 can further include the output block 140. The output block 140 can process an output from the last attention block in the sequence of attention blocks (e.g., from the local cross-attention block 120 in FIG. 1) to generate the network output 108 characterizing the entity. For example, the output block 140 can pool (i.e., combine, e.g., average pool or max pool) the latent embeddings included in the output to generate a pooled latent embedding, e.g., a global summary vector. The output block 140 can process the pooled latent embedding using one or more neural network layers included in the output block 140 to generate the network output 108. For example a single linear neural network layer can project the global summary vector to a number of target classes or categories to provide a classification output. In some implementations, the network output 108 can have a sequence of output elements. In such cases, at each time step in a sequence of time steps, the output block 140 can process the output from the last attention block in the sequence of attention blocks and the output elements generated at any preceding time step to generate an output element for the time step.

The neural network system 100 can further include a training engine 180 that can train the neural network 160 on a set of training data over multiple training iterations. The training data can include a set of training examples, where each training example specifies: (i) a training input, and (ii) a target output that should be generated by the neural network 160 by processing the training input.

At each training iteration, the training engine 180 can sample a batch of training examples from the training data, and process the training inputs specified by the training examples using the sequence of neural network blocks included in the neural network 160 to generate corresponding network outputs. In particular, for each training input, the neural network 160 processes the training input using the current model parameter values of a first attention block in the sequence (e.g., the local cross-attention block 120 in FIG. 1) to generate an output from the first attention block. The neural network 160 processes the output generated by the first attention block in the sequence using the current model parameter values of a second attention block in the sequence (e.g., the self-attention block 130 in FIG. 1) to generate an output from the second attention block in the sequence. The neural network 160 processes an output generated by the last attention block in the sequence (e.g., the local cross-attention block 120 in FIG. 1) using the current model parameter values of the output block 140 to generate the network output corresponding to the training input.

The training engine 180 can adjust the model parameter values of the attention blocks 120, 130, 170 and the output block 140 to optimize an objective function that measures a similarity between: (i) the network outputs generated by the neural network 160, and (ii) the target network outputs specified by the training examples. The objective function can be, e.g., a cross-entropy objective function, a squared-error objective function, or any other appropriate objective function.

The training engine 180 can determine gradients of the objective function, e.g., using backpropagation techniques. The training engine 180 can update the model parameter values of the attention blocks 120, 130, 170 and the output block 140 using the gradients, e.g., using any appropriate gradient descent optimization algorithm, e.g., Adam. The training engine 180 can determine a performance measure of the neural network 160 on a set of validation data that is not used during training of the neural network 160.

As described above, in addition to obtaining the set of latent embeddings 102 and the set of data element embeddings 104, the neural network system 100 can additionally obtain the set of positional embeddings 106, where each positional embedding represents a position of a corresponding data element embedding in the representation of the entity. The training engine 180 can train the set of positional embeddings 106, e.g., by masking a portion of the representation of the entity (e.g., as the set of data element embeddings 104) before the representation of the entity is provided to the neural network 160. Generally, “masking” a part of a dataset can refer to modifying the dataset to remove some or all of the information content represented by the part of the dataset, e.g., by replacing the part of dataset by default (e.g., predefined or random) values, or by removing the part of the dataset.

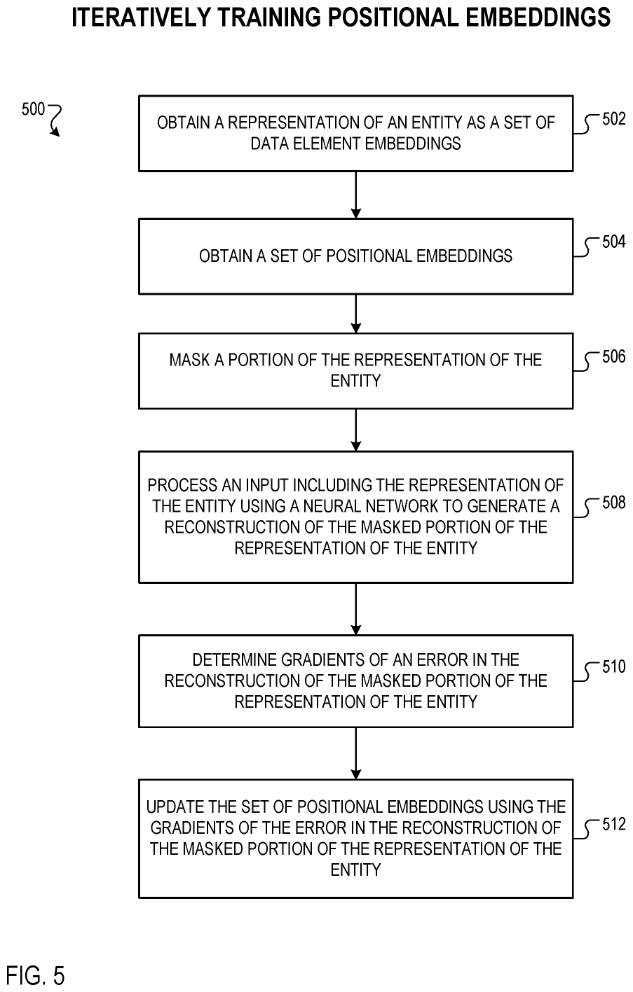

The training engine 180 can use the set of positional embeddings 106 to augment the set of data element embeddings 104 that have been partially masked. After augmenting the set of data element embeddings 104 in this manner, the training engine 180 can process the set of data element embeddings 104 using the neural network 160 (e.g., as described above) to generate a reconstruction of the masked portion of the data element embeddings 104. The training engine 180 can iteratively adjust the positional embeddings 106 to optimize a reconstruction objective function that measures an error in the reconstructions generated by the neural network 160, e.g., by backpropagating gradients of the objective function into the positional embeddings 106. The reconstruction objective function can provide a rich gradient signal for learning highly informative positional embeddings 106. An example process for iteratively training the set of positional embeddings 106 is described in more detail below with reference to FIG. 5.

After training the set of positional embeddings 106 in this manner, the neural network system 100 can tag, or concatenate, the trained set of positional embeddings 106 to the set of data element embeddings 104, to incorporate the information regarding the spatial arrangement of the data element embeddings 104. Then, the neural network system 100 can process the set of data element embeddings 104 and the set of latent embeddings 102, e.g., as described above, to generate the network output 108 characterizing the entity. In this manner, the attention operations described above can draw on the positional information encoded by the set of positional embeddings 106 when relevant to generating accurate network outputs 108. Therefore, the neural network system 100 can be used to process sets of data element embeddings 104 that are not associated with a predefined spatial arrangement, e.g., sets of data elements representing points clouds or proteins, thereby making the system more broadly applicable. The process of training the set of positional embeddings 106 is described in more detail below with reference to FIG. 5.

After training of the neural network 160 and/or the set of positional embeddings 106, the neural network system 100 can be used to perform a machine learning task, e.g., to process an input and generate an output characterizing an entity.

The neural network system 100 can be configured to perform any appropriate machine learning task. A few examples follow.

In some implementations, the system uses the neural network to process a set of data element embeddings that represent the pixels of a still or moving image, or that represent audio-visual data, to generate a classification output, e.g. a multi-label classification output, that includes a respective score for each category in a set of categories. The categories in the set of categories can be, e.g., object categories, e.g., corresponding to vehicle, pedestrian, bicyclist, etc., or for video, action categories e.g. for human-object interactions, or for human-human interactions such as shaking hands, or for gesture recognition. For audio-visual data the categories can comprise event categories, where an event is characterized by a combination of sound and vision, e.g. a baby crying, tool use, a cymbal, a dog barking, fireworks, a crowd cheering, wind blowing, and so forth. The score for an object or event category can define a likelihood that the image depicts an object that belongs to the object category or that an event belongs to the event category. As another example where data element embeddings represent pixels, the task may be a segmentation task that assigns each of a plurality of pixels of the image to a category from a set of categories, to generate a segmentation output that assigns a respective probability for each of the categories for each pixel in the image.

In some implementations, the system uses the neural network to process a set of data element embeddings that represent audio samples in an audio waveform to perform speech recognition, i.e., to generate an output that defines a sequence of phonemes, graphemes, characters, or words corresponding to the audio waveform.

In some implementations, the system uses the neural network to process a set of data element embeddings that represent words in a sequence of words to perform a natural language processing task, e.g., topic classification or summarization. To perform topic classification, the system uses the neural network to generate a network output that includes a respective score for each topic category in a set of possible category categories (e.g., sports, business, science, etc.). The score for a topic category can define a likelihood that the sequence of words pertains to the topic category. To perform summarization, the system uses the neural network to generate a network output that includes an output sequence of words that has a shorter length than the input sequence of words and that captures important or relevant information from the input sequence of words.

In some implementations, the system uses the neural network for a neural machine translation task, e.g., to process a set of data element embeddings that represent a sequence of text, e.g., a sequence of words, phrases, characters, or word pieces, in one language, to generate a network output that may be a translation of the sequence of text into another language, i.e., a sequence of text in the other language that is a translation of the input sequence of text. As a particular example, the task may be a multilingual machine translation task, where the neural network is configured to translate between multiple different source languages—target language pairs. In this example, the source language text may be augmented with an identifier that indicates the target language into which the neural network should translate the source language text.

In some implementations, the system uses the neural network to perform an audio processing task. For example, if the data element embeddings represent a spoken utterance, then the output generated by the neural network may be a score for each of a set of pieces of text, each score representing an estimated likelihood that the piece of text is the correct transcript for the utterance. As another example, if the data element embeddings represent a spoken utterance, the output generated by the neural network can indicate whether a particular word or phrase (“hotword”) was spoken in the utterance. As another example, if the data element embeddings represent a spoken utterance, the output generated by the neural network can identify the natural language in which the utterance was spoken. More generally the audio processing task may be to detect or classify the input audio and the output may indicate detection of an audio event and/or may define a score for each category in a set of categories of audio events.

In some implementations, the system uses the neural network to perform a natural language processing or understanding task, e.g., an entailment task, a paraphrase task, a textual similarity task, a sentiment task, a sentence completion task, a grammaticality task, and so on, that operates on a set of data element embeddings representing text in some natural language.

In some implementations, the system uses the neural network to perform a text to speech task, where the data element embeddings represent text in a natural language or features of text in a natural language and the network output is a spectrogram, a waveform, or other data defining audio of the text being spoken in the natural language.

In some implementations, the system uses the neural network to perform a health prediction task, where the data element embeddings represent data derived from patient sequence data for a patient and the output is a prediction that is relevant to the future health of the patient, e.g., a predicted treatment that should be prescribed to the patient, the likelihood that an adverse health event will occur to the patient, or a predicted diagnosis for the patient.

In some implementations, the system uses the neural network to perform a text generation task, where the data element embeddings represent a sequence of text, and the output is another sequence of text, e.g., a completion of the input sequence of text, a response to a question posed in the input sequence, or a sequence of text that is about a topic specified by the first sequence of text. As another example, the data element embeddings can represent data other than text, e.g., an image, and the output sequence can be text that describes the data represented by the data element embeddings.

In some implementations, the system uses the neural network to perform an image generation task, where the data element embeddings represent a conditioning input, e.g. specifying one or more features of the image, and the output is a sequence of intensity value inputs for the pixels of an image, e.g. with the feature(s).

In some implementations, the system uses the neural network to perform an agent control task, where the data element embeddings represent a sequence of one or more observations or other data characterizing states of an environment, e.g. a real world environment, and the output defines an action to be performed by the agent in response to the most recent data in the sequence, in particular to perform a task. The agent can be a mechanical agent, e.g. a robot or vehicle, controlled to perform actions in the real world environment, in response to the observations, to perform the task, e.g. to manipulate an object or to navigate in the environment. Thus the agent can be, e.g., a real-world or simulated robot; as some other examples the agent can be a control system to control one or more machines in an industrial facility, or a control system that controls a different kind of agent.

In some implementations, the system uses the neural network to perform a genomics task, where the data element embeddings represent a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on. Thus the network output can indicate prediction of a sequence property such as having a promoter site, methylation, or predicting functional effects of a non-coding variant; and/or may define scores for elements of the sequence in accordance with such a sequence property.

In some implementations, the system uses the neural network to perform a protein modeling task, e.g., where the data element embeddings represent a protein and the network output characterizes the protein. For example, the network output can characterize a predicted stability of the protein or a predicted 3D structure of the protein. For DNA or protein modeling tasks the system can be trained from real-world experimental data. The protein modeling task may be used to identify and physically synthesize a protein.

In some implementations, the system uses the neural network to perform a point cloud processing task, e.g., where the data element embeddings represent a point cloud (e.g., generated by a lidar or radar sensor) and the network output characterizes, e.g., a type of object represented by the point cloud. In general the types of task that can be performed where the entity includes a point cloud correspond to those described above for a still or moving image or multimodal, e.g. audio-visual input.

In some implementations, the system uses the neural network to perform a combination of multiple individual machine learning tasks, i.e., the system is configured to perform multiple different individual machine learning tasks, e.g., two or more of the machine learning tasks mentioned above. For example, the system can be configured to perform multiple individual natural language understanding tasks, with the data element embeddings processed by the neural network include an identifier for the individual natural language understanding task to be performed on data element embeddings.

In some implementations, the system 100 implements a diffusion model. More specifically, the system 100 can train the neural network 160 to process a network input that includes a noisy version of a dataset to generate a network output that characterizes the original (de-noised) dataset. For instance, the network output can define a prediction of the original dataset, or the network input can define a prediction of the noise that was added to the original dataset to generate the noisy dataset. The dataset can be any appropriate dataset, e.g., a dataset representing an image, or a video, or an audio waveform, etc.

In implementations where the system implements a diffusion model, the system can use the neural network as a generative model to generate new datasets. For instance, the system can instantiate a current dataset by randomly sampling the dataset from a predefined distribution, e.g., a standard Normal distribution. Next, at each de-noising iteration in a sequence of de-noising iterations, the system can process the current dataset using the neural network to generate a prediction characterizing a de-noised version of the dataset. The system can then update the current dataset using the prediction for the de-noised dataset, e.g., by setting the current dataset equal to the prediction for the de-noised dataset, or by setting the current dataset equal to a function of the prediction for the de-noised dataset. (The function of the prediction for the de-noised dataset can be, e.g., a combination of the de-noised dataset with additional noise). After performing the sequence of de-noising iterations, the current dataset can represent a new dataset (e.g., a new image, or a new video, or a new audio waveform), i.e., that has been sampled by the diffusion model.

In some cases, the diffusion model can operate in a latent space. More specifically, the neural network can be configured to process a dataset that represents a point in a latent space. In these cases, generating a new dataset includes generating a new dataset that represents a new point in the latent space. The system can process the new dataset generated by the diffusion model using a decoder neural network to generate a new data in a data space, i.e., a space of images, or a space of videos, or a space of audio waveforms, etc. That is, the decoder neural network can decode the new dataset, representing a point in the latent space, to generate a corresponding new dataset representing a point in the data space, e.g., a new image, or a new video, or a new audio waveform.

The decoder neural network can be jointly trained along with an encoder neural network to operate as an autoencoder. More specifically, for each of multiple datasets in the data space, the encoder neural network can process the dataset to generate a corresponding dataset in the latent space. The decoder neural network can then process the dataset in the latent space to generate a predicted reconstruction of the original dataset in the data space. The encoder neural network and the decoder neural network can be jointly trained to optimize a loss function that, for each of multiple datasets in the data space, measures an error between: (i) the dataset in the data space, and (ii) a reconstruction version of the dataset in the data space. The reconstruction version of the dataset in the data space can be generated by processing the dataset in the data space using the encoder neural network to generate a corresponding dataset in the latent space, and then processing the dataset in the latent space using the decoder neural network to generate the reconstructed version of the dataset in the data space.

The neural network system 100 is described in more detail below with reference to FIG. 2.

FIG. 2 is a block diagram of an example neural network system 200 (e.g., the neural network system 100 in FIG. 1) in more detail. The neural network system 200 is an example of a system implemented as computer programs on one or more computers in one or more locations in which the systems, components, and techniques described below are implemented.

The neural network system 200 can include a sequence of neural network blocks, e.g., one or more local cross-attention blocks 230 and one or more self-attention blocks 240. In some cases, the system 100 can further include one or more global cross-attention blocks (not shown). A particular example is illustrated in FIG. 2, where the neural network system 200 includes a local cross-attention block 230 followed by a self-attention block 240. As described above with reference to FIG. 1, the neural network system 200 can use the sequence of neural network blocks to process a set of data element embeddings 210 representing an entity, a set of latent embeddings (not shown) and, in some cases, a set of positional embeddings (not shown), to generate a network output characterizing the entity.

As illustrated in FIG. 2, the local cross-attention block 230 can be configured to partition the set of data element embeddings 210 into proper subsets of data element embeddings 215, e.g., a first subset 215a, a second subset 215b, a third subset 215c, and a fourth subset 215d. Similarly, the local cross-attention block 230 can be configured to partition the set of latent embeddings into proper subsets of latent embeddings 235, e.g., a first subset 235a, a second subset 235b, a third subset 235c, and a fourth subset 235d. Although four proper subsets of the set of data element embeddings 210 and four proper subsets of the set of latent embeddings are illustrated in FIG. 2, generally, the local cross-attention block 210 can partition the set of data element embeddings 210 and the set of latent embeddings into any appropriate number of proper subsets, e.g., 2 subsets, 10 subsets, 100 subsets, 100 subsets, 1,000 subsets, 10,000 subsets, or any other appropriate number of subsets.

For each proper subset of latent embeddings 235, the local cross-attention block 230 can identify a corresponding proper subset of data element embeddings 215. For example, as illustrated in FIG. 2, for the first subset of latent embeddings 235a, the local cross-attention block 230 can assign the first subset of data element embeddings 215a. Similarly, for the second subset of latent embeddings 235b, the local cross-attention block 230 can assign the second subset of data element embeddings 215b.

After identifying, for each subset of latent embeddings 235, a corresponding subset of data element embeddings 215, the local cross-attention block 230 can perform a local cross-attention operation. That is, the local cross-attention block 230 can update each latent embedding in the subset of latent embeddings 235 using cross-attention over only the corresponding subset of data element embeddings 215. For example, the local cross-attention block 230 can update each latent embedding in the first subset of latent embeddings 235a using attention only over the first subset of data element embeddings 215a. Similarly, the local cross-attention block 230 can update each latent embedding in the second subset of latent embeddings 235b using attention only over the second subset of data element embeddings 215b. The local cross-attention block 230 can repeat this process for all proper subsets of the set of latent embeddings 235.

As described above, the neural network system 200 can further include the self-attention block 240 that follows the local cross-attention block 230 in the sequence of neural network blocks. The self-attention block 240 can be configured to update each subset of latent embeddings 235 that were updated by the local cross-attention block 230 over the same subset of latent embeddings 235. For example, the self-attention block 240 can update each latent embedding in the first subset of latent embeddings 235a using attention over the first subset of latent embeddings 235a. Similarly, the self-attention block 230 can update each latent embedding in the second subset of latent embeddings 235b using attention over the second subset of latent embeddings 235b. The self-attention block 240 can repeat this process for all proper subsets of the set of latent embeddings 235.

As illustrated in FIG. 2, the neural network system 200 can merge the subsets of latent embeddings, e.g., merge the first subset 235a, the second subset 235b, the third subset 235c, and the fourth subset 235d, of latent embeddings, to generate a full set of latent embeddings 260.

As described above with reference to FIG. 1, in some cases, the neural network system 200 can be configured to perform multiple local cross-attention operations with various degrees of localization. For example, the neural network system 200 can perform a hierarchy of local cross-attention operations using a sequence of local cross-attention blocks 230, where each local cross-attention block 230 in the sequence partitions the set of latent embeddings and the set of data element embeddings 210 into fewer subsets 235, 215, respectively. This is described in more detail below with reference to FIG. 3.

FIG. 3 illustrates example sequences of local cross-attention blocks 300 that can be included in a neural network system (e.g., the neural network system 100 in FIG. 1 or the neural network system 200 in FIG. 2). The sequences of local cross-attention blocks 300 are an example of a system implemented as computer programs on one or more computers in one or more locations in which the systems, components, and techniques described below are implemented.

As described above with reference to FIG. 1 and FIG. 2, the neural network system can include a sequence of neural network blocks that can include one or more local cross-attention blocks and an output block. The neural network system can use the sequence of neural network blocks to process a set of data element embeddings 302 (e.g., “Input” in FIG. 3) representing an entity, and a set of latent embeddings (e.g., initialized randomly), to generate a network output 304 (e.g., “Output” in FIG. 3) characterizing the entity. Each local cross-attention block can be configured to partition the set of data element embeddings 302 and the set of latent embeddings into proper subsets. Then, each local cross-attention block can identify, for each subset of latent embeddings, a corresponding subset of data element embeddings, and use the subsets to perform the cross-attention operation, e.g., as described above.

In some cases, the neural network system can include one or more sequences of local cross-attention blocks 300. For example, the neural network system can include a locality-reducing sequence of local cross-attention blocks 310. Each local cross-attention block in the locally-reducing sequence of local cross-attention blocks 310 can be configured to partition the set of data element embeddings 302 into a smaller number of proper subsets than a preceding local cross-attention block in the locality-reducing sequence of local cross-attention blocks.

For example, as illustrated in FIG. 3, the locally-reducing sequence 310 includes a first local cross-attention block 310a and a second local cross-attention block 310b. The first local cross-attention block 310a is configured to partition the set of data element embeddings 302 into four subsets of data element embeddings (e.g., x₀⁰, x₁⁰, x₂⁰, x₃⁰). The next local cross-attention block in the locally-reducing sequence 310, e.g., the second local cross-attention block 310b, is configured to partition the set of data element embeddings 302 into a smaller number of subsets than the previous local cross-attention block, e.g., into two subsets of data element embeddings (e.g., x₀¹, x₁¹).

In some cases, the neural network system can include a locality-increasing sequence of local cross-attention blocks 330. Each local cross-attention block in the locally-increasing sequence of local cross-attention blocks 330 can be configured to partition the set of data element embeddings 302 into a greater number of proper subsets than a preceding local cross-attention block in the locality-increasing sequence of local cross-attention blocks 330.

For example, as illustrated in FIG. 3, the locally-increasing sequence 330 includes a fourth local cross-attention block 310d and a fifth local cross-attention block 310e. The fourth local cross-attention block 310d is configured to partition the set of data element embeddings 302 into two subsets of data element embeddings (e.g., x₀³, x₁³). The next local cross-attention block in the locally-increasing sequence 330, e.g., the fifth local cross-attention block 310e, is configured to partition the set of data element embeddings 302 into a greater number of subsets than the previous local cross-attention block, e.g., into four subsets of data element embeddings (e.g., x₀⁴, x₁⁴, x₂⁴, x₃⁴).

In some cases, the locality-reducing sequence of local cross-attention blocks 310 can precede the locality-increasing sequence of local cross-attention blocks 330 in the neural network system. In some cases, the neural network system can further include one or more global cross-attention blocks 310c. The global cross-attention block 310c can be configured to perform the cross-attention operation using the entire set (e.g., x₀²) of data element embeddings 302, as described above with reference to FIG. 1. For example, as illustrated in FIG. 3, the neural network system can include the first cross-attention block 310a of the locality-reducing sequence 310, followed by the second cross-attention block 310b of the locality-reducing sequence 310, followed by the global cross-attention block 310c, followed by the fourth cross-attention block 310d of the locality-increasing sequence 330, followed by the fifth cross-attention block 310e of the locality-increasing sequence 330.

Although particular examples of sequences of local cross-attention blocks 300 are described above with reference to FIG. 3, in general, the local cross-attention blocks can be arranged in any appropriate configuration in the neural network system. In one example, the neural network system can include only the locality-reducing sequence 310 of local cross-attention blocks. In another example, the neural network system can include only the locality-increasing sequence 330 of local cross-attention blocks.

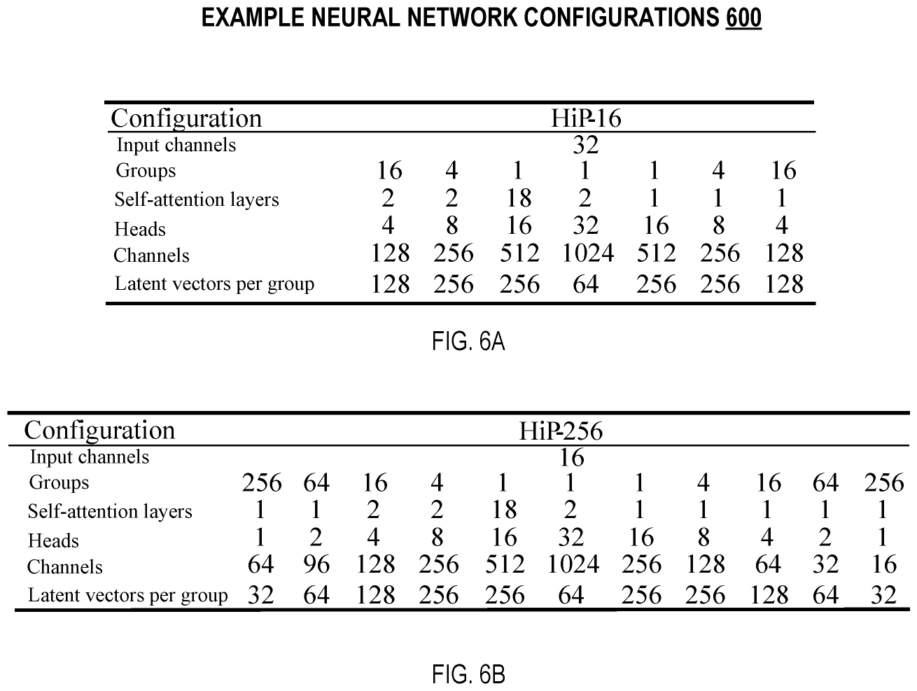

In yet another example, the neural network system can include a sequence of local cross-attention blocks where each local cross-attention block is configured to partition the set of data element embeddings into any appropriate number of proper subsets, e.g., non-sequentially. As a particular example, a first local cross-attention block in the sequence can be the global cross-attention block, a second local cross-attention block in the sequence can partition the set of data element embeddings into eight subsets, a third local cross-attention block in the sequence can partition the set of data element embeddings into two subsets, and the last local cross-attention block in the sequence can partition the set of data element embeddings into four subsets (e.g., 1-8-2-4 configuration). Furthermore, the neural network system can include any number and type of neural network blocks (e.g., one or more self-attention blocks, global cross-attention blocks, or any other appropriate neural network blocks) before, after, and/or between the local cross-attention blocks. Example configurations of the neural network system are described in more detail below with reference to FIG. 6A and FIG. 6B.

An example process for using the neural network system to generate the network output characterizing the entity is described in more detail next.

FIG. 4 is a flow diagram of an example process 400 for using a neural network to generate a network output that characterizes an entity. For convenience, the process 400 is described as being performed by a system of one or more computers located in one or more locations. For example, a neural network system, e.g., the neural network system 100 of FIG. 1, appropriately programmed in accordance with this specification, can perform the process 400.

The system obtains a representation of the entity as a set of data element embeddings (402). In some cases, the set of data element embeddings can include at least one million data element embeddings. The set of data element embeddings can represent, for example, one or more of: an image, an audio waveform, or a point cloud.

The system obtains a set of latent embeddings (404). For example these may be obtained as random or default e.g. learned values. In some cases, a number of latent embeddings in the set of latent embeddings can be less than a number of data element embeddings in the set of data element embeddings. In some cases, a number of latent embeddings in the set of latent embeddings can be predefined and independent of a number of data element embeddings in the set of data element embeddings.

The system processes: (i) the set of data element embeddings, and (ii) the set of latent embeddings, using the neural network to generate the network output characterizing the entity (406). The neural network can include a sequence of neural network blocks including: (i) one or more local cross-attention blocks, and (ii) an output block. In some cases, the neural network can include multiple local cross-attention blocks and multiple self-attention blocks, that can be, e.g., interleaved.

Each local cross-attention block can perform operations that include: determining a partition of the set of latent embeddings into multiple proper subsets of the set of latent embeddings, and a partition of the set of data element embeddings into multiple proper subsets of the set of data element embeddings. For example, for each local cross-attention block, the set of latent embeddings can be partitioned into the same number of proper subsets as the set of data element embeddings. As another example, for each local cross-attention block, each proper subset of the latent embeddings can correspond to a different proper subset of the data element embeddings.

In some cases, the neural network can include a locality-reducing sequence of local cross-attention blocks. In such cases, for each local cross-attention block after a first local cross-attention block in the locality-reducing sequence of local cross-attention blocks: the local cross-attention block can partition the set of data element embeddings into a smaller number of proper subsets than a preceding local cross-attention block in the locality-reducing sequence of local cross-attention blocks. In some cases, the neural network can include a locality-increasing sequence of local cross-attention blocks. In such cases, for each local cross-attention block after a first local cross-attention block in the locality-increasing sequence of local cross-attention blocks: the local cross-attention block can partition the set of data element embeddings into a greater number of proper subsets than a preceding local cross-attention block in the locality-increasing sequence of local cross-attention blocks.

The sequences of local cross-attention blocks can be configured in various ways. For example, the locality-reducing sequence of local cross-attention blocks can precede the locality-increasing sequence of local cross-attention blocks in the neural network. As another example, the neural network can include one or more global cross-attention blocks between the locality-reducing sequence of local cross-attention blocks and the locality-increasing sequence of local cross-attention blocks.

The operations can further include: identifying, for each proper subset of latent embeddings, a corresponding proper subset of the data element embeddings. The operations can further include: updating each proper subset of the set of latent embeddings using attention over only the corresponding proper subset of the set of data element embeddings. This can include, for example, for each local cross-attention block, and for each latent embedding in the proper subset of the latent embeddings: determining, for each data element embedding in the corresponding proper subset of the data element embeddings, a respective attention weight for the data element embedding based on: (i) the data element embedding, and (ii) the latent embedding. This can further include updating the latent embedding using: (i) the attention weights, and (ii) the corresponding proper subset of the data element embeddings.

The output block can perform operations including: after the set latent embeddings are updated using the one or more cross-attention blocks, processing one or more latent embeddings from the set of latent embeddings to generate the network output characterizing the entity.

In some cases, the neural network can further include one or more self-attention blocks. Each self-attention block can perform operations including: updating the set of latent embeddings using attention over the set of latent embeddings.

In some cases, the neural network can further include one or more global cross-attention blocks. Each global cross-attention block performs operations including: updating the set of latent embeddings using attention over the set of data element embeddings.

In some implementations, the system can obtain a set of positional embeddings, where each positional embedding can represent a position of a corresponding data element embedding in the representation of the entity. In such cases, processing: (i) the set of data element embeddings, and (ii) the set of latent embeddings, using the neural network, can include: updating each data element embedding using a respective positional embedding representing the position of the data element embedding, e.g. by adding or concatenating the positional embedding. In some cases, the system can mask a portion of the representation of the entity before the representation of the entity is provided to the neural network. In such cases, the network output can include a reconstruction of the masked portion of the representation of the entity. In some cases, the system can determine gradients of an error in the reconstruction of the masked portion of the representation of the entity. Then, the system can update the set of positional embeddings using the gradients of the error in the reconstruction of the masked portion of the representation of the entity.

FIG. 5 is a flow diagram of an example process 500 for iteratively training a set of positional embeddings. For convenience, the process 500 is described as being performed by a system of one or more computers located in one or more locations. For example, a neural network system, e.g., the neural network system 100 of FIG. 1, appropriately programmed in accordance with this specification, can perform the process 500.

As described above with reference to FIG. 1, the system can include a neural network that can be configured to process a set of latent embeddings and a set of data element embeddings to generate a network output characterizing an entity. The system can further include a training engine that can train the neural network and the set of positional embeddings on a set of training data over multiple training iterations. The training data can include a set of training examples, where each training example specifies: (i) a training input, and (ii) a target output that should be generated by the neural network by processing the training input. Specifically, each training input can include, e.g., a masked representation of the entity (e.g., as described below in step (506)). Each target output can include, e.g., an un-masked representation of the entity. The process steps (502)-(512) below describe an example process for training the positional embeddings on a single training example from the set of training examples. In particular, the steps (502)-(512) can be performed iteratively, e.g., over a sequence of training iterations, e.g., by way of a stochastic gradient descent training technique.

At each training iteration, the system can obtain a representation of an entity as the set of data element embeddings (502), and the set of positional embeddings (504). Prior to the first training iteration, the system can initialize the set of positional embeddings in any appropriate manner, e.g., by randomly sampling the value of each entry of each positional embedding from a distribution, e.g., a standard Normal distribution. In some cases, the system can randomly initialize positional embeddings as, e.g., a vector in latent space having, e.g., 16 components, or 32 components. At each subsequent training iteration after the first training iteration, the system can obtain the current values of the set of positional embeddings, e.g., the values of the set of positional embeddings that were generated at the previous training iteration.

The system can mask a portion of the representation of the entity (506) by, e.g., modifying the representation of the entity to remove some or all of the information content represented by the part of the representation of the entity, e.g., by replacing the part of the representation of the entity by default (e.g., predefined or random) values, or by removing the part of the representation of the entity.

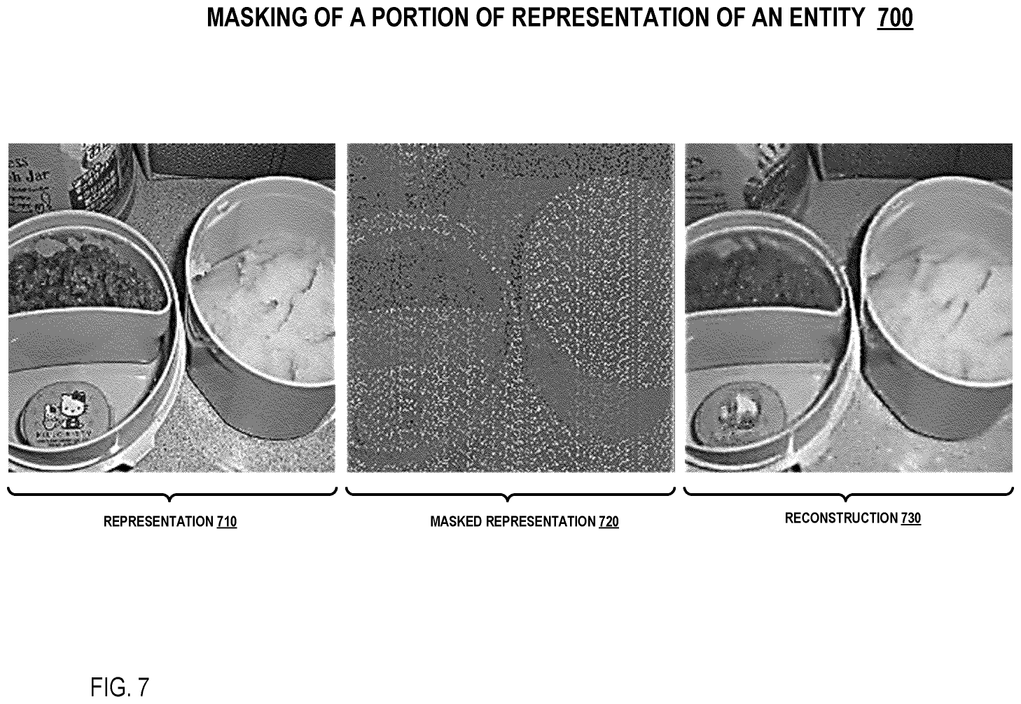

In some cases, the system can select a portion of the representation of the entity to be masked, e.g., by randomly and/or uniformly selecting a predefined fraction of the representation of the entity, e.g., 1%, 10%, 50%, 70%, 85%, or 90%, of the set of data element embeddings representing the entity. After selecting the portion of the representation of the entity, the system can apply a masking operation to the selected portion of the representation of the entity. For example, the system can replace the selected portion of the representation of the entity by default data, e.g., zero values. As another example, the system can remove the selected portion of the representation of the entity. Example masking of a portion of the representation of the entity is illustrated in FIG. 7.

At each training iteration, the system can process the training input specified by the training example (e.g., the masked representation of the entity and the set of positional embeddings) using the neural network to generate a corresponding network output, e.g., a reconstruction of the masked portion of the representation of the entity (508). For example, the system can update each data element embedding using a respective positional embedding representing the position of the data element embedding. As a particular example, the system can tag (e.g., concatenate) each data element embedding with the respective positional embedding. Then, the system can process the updated data element embeddings, by one or more neural network layers of the neural network, to generate the reconstruction of the masked portion of the representation of the entity.

At each training iteration, the training engine can adjust model parameter values of the neural network to optimize an objective function that measures an error in the reconstruction of the masked portion of the representation of the entity. In other words, the objective function can measure a similarity between: (i) the network output generated by the neural network, and (ii) the target network output specified by the training example. The objective function can be, e.g., a cross-entropy objective function, a squared-error objective function, or any other appropriate objective function. The reconstruction objective function can provide a rich gradient signal for learning highly informative positional embeddings.

At each training iteration, the training engine can determine gradients of the objective function, e.g., using backpropagation techniques (510). The training engine can backpropagate gradients through the neural network layers of the neural network and into the set of positional embeddings. The training engine can update the model parameter values of the neural network and the set of positional embeddings using the gradients (512), e.g., using any appropriate gradient descent optimization algorithm, e.g., Adam.

After training the set of positional embeddings in this manner (e.g., using multiple training examples and over multiple training iterations), the system can use the set of positional embeddings to flexibly incorporate information regarding the spatial arrangement of the data element embeddings by tagging (e.g., concatenating) positional embeddings to the data element embeddings, and allowing the attention operations to learn to draw on this information when relevant to generating accurate network outputs. Therefore, the system described in this specification can be used to process sets of data element embeddings that are not associated with a predefined spatial arrangement, e.g., sets of data elements representing points clouds or proteins, thereby making the system more broadly applicable. Moreover, the learned positional embeddings can be significantly more compact than conventional positional embeddings and thus enable reduced consumption of computational resources.

In some cases, the system can train the set of positional embeddings in the manner described above as a pre-training step, e.g., to train the set of positional embeddings and pre-train the neural network layers of the neural network. After the pre-training step, the system can train (e.g., fine-tune) the neural network on a downstream prediction task, e.g., on any of the tasks described above with reference to FIG. 1.

Example configurations of the neural network system are described in more detail below with reference to FIG. 6A and FIG. 6B.

FIGS. 6A and 6B illustrate example configurations of a neural network system (e.g., the neural network system 100 in FIG. 1 or the neural network system 200 in FIG. 2). In particular, FIG. 6A illustrates the configuration of a neural network system (e.g., “HiP-16”) having one or more local cross-attention blocks that partition a set of data element embeddings into at most 16 proper subsets (e.g., “Groups'). Specifically, the configuration of the neural network system is symmetrical and includes a sequence of local cross-attention blocks, where each local cross-attention block in the sequence partitions the set of data element embeddings into a number of subsets as follows: 16-4-1-1-1-4-16.

FIG. 6B illustrates the configuration of a neural network system (e.g., “HiP-256”) having one or more local cross-attention blocks that partition the set of data element embeddings into at most 256 proper subsets (e.g., “Groups'). Specifically, the configuration of the neural network system is symmetrical and includes a sequence of local cross-attention blocks, where each local cross-attention block in the sequence partitions the set of data element embeddings into a number of subsets as follows: 256-64-16-4-1-1-1-4-16-64-256. Other hyperparameters of the neural network system for each local cross-attention block, such as the number of latent embeddings (e.g., vectors) per group, are also shown in FIG. 6A and FIG. 6B.

FIG. 7 illustrates an example representation of an entity that has been partially masked by a neural network system (e.g., the neural network system 100 in FIG. 1, or the neural network system 200 in FIG. 2). As described above, the neural network system can mask a portion of the representation 710 of the entity as a set of data element embeddings to generate a masked representation 720 of the entity. As shown by the masked representation 720 of the entity in FIG. 7, the system masked 85% of the data element embeddings representing the entity.

After generating the masked representation 720 of the entity, the system can use the masked representation 720 to train a set of positional embeddings. Specifically, the system can use the positional embeddings to augment the set of data element embeddings that have been partially masked, e.g., the masked representation 720 of the entity. Then, the system can use a neural network (e.g., the neural network 160 in FIG. 1) to process the set of data element embeddings that have been partially masked (e.g., the masked representation 720) to generate a reconstruction 730 of the masked portion of the data element embeddings. The system can iteratively adjust the positional embeddings to optimize a reconstruction objective function that measures an error in the reconstruction 730 generated by the neural network, e.g., by backpropagating gradients of the objective function into the positional embeddings.

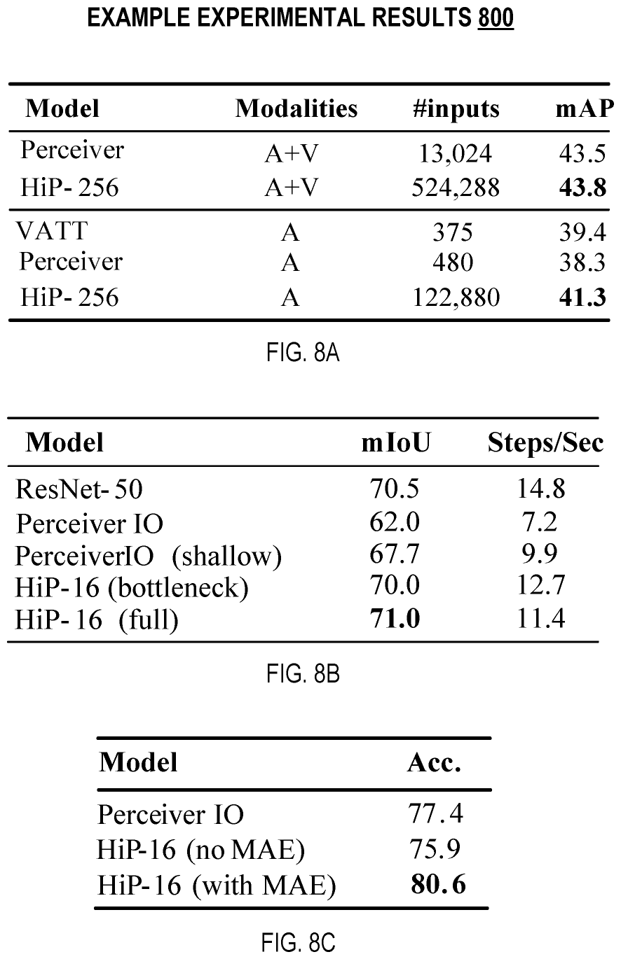

FIG. 8A, FIG. 8B, and FIG. 8C illustrate example experimental results 800 achieved using the neural network system described in this specification. In particular, FIG. 8A illustrates experimental results achieved with a multi-modal entity, e.g., an entity that includes both audio and video data. FIG. 8B, illustrates results on a semantic segmentation task. FIG. 8C illustrates results on a point cloud classification task. All cases show top-1 accuracy (higher is better) of the neural network system described in this specification (e.g., “HiP-256” and “HiP-16”) and alternative neural network systems. It can be appreciated that the neural network system described in this specification significantly outperforms the alternative systems without relying on domain-specific architectural assumptions. Furthermore, it can be appreciated that, in some cases, as illustrated in FIG. 8C, the neural network system described in this specification can outperform other available systems especially when utilizing masking for training positional embeddings (e.g., “with MAE”).

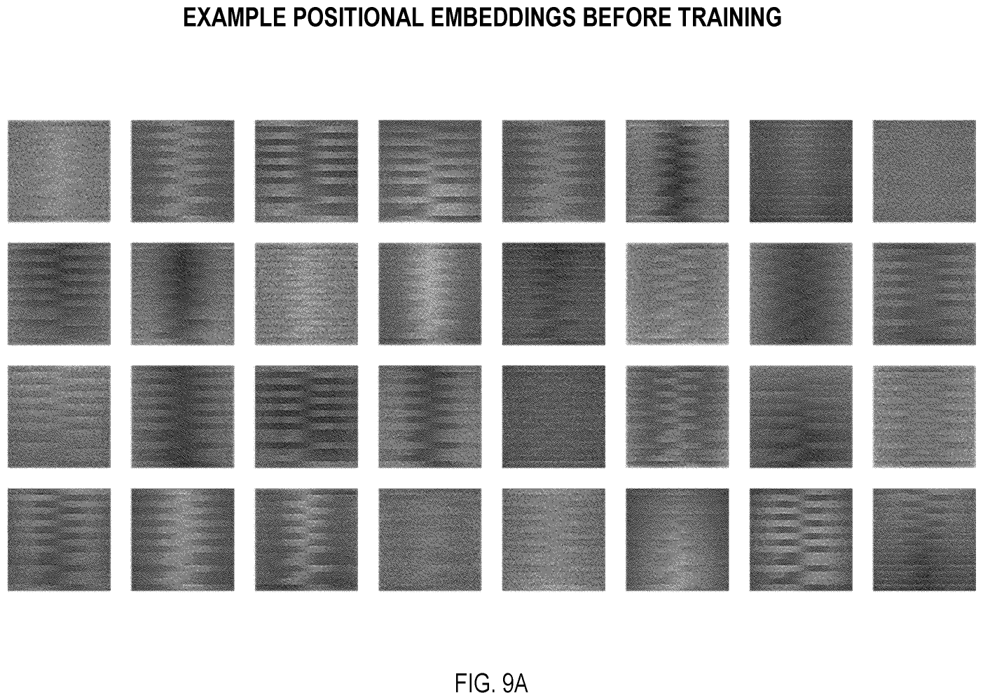

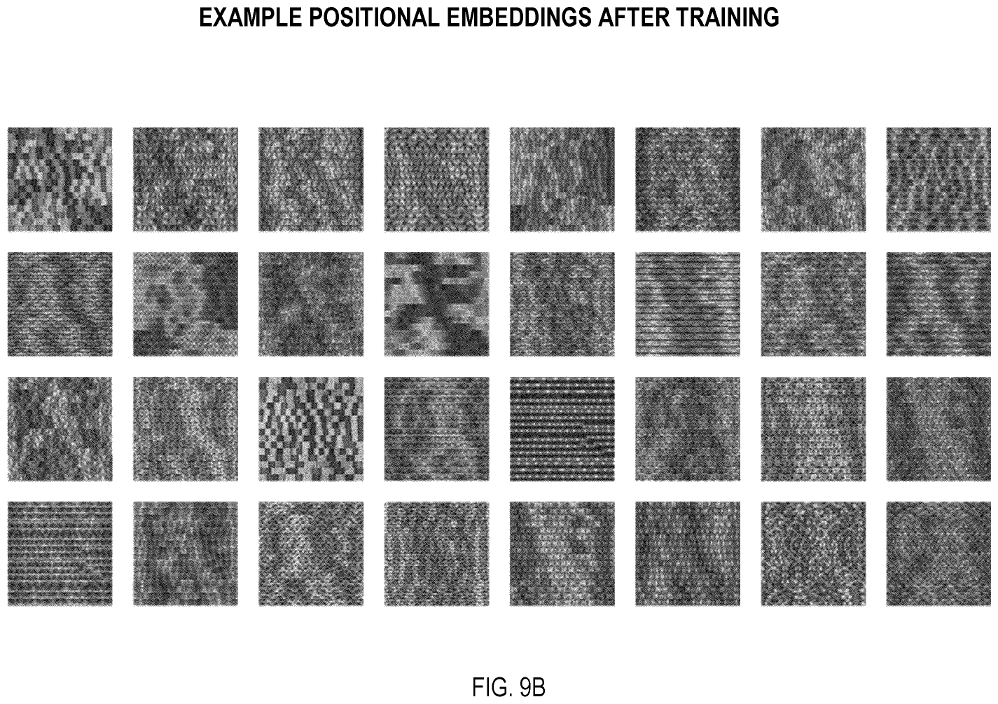

FIG. 9A and FIG. 9B illustrate an example set of positional embeddings before and after training, respectively. In particular, the set of positional embeddings has been trained using the process of masking described above with reference to FIG. 5, and “HiP-16” neural network system described above with reference to FIG. 6A. It can be appreciated that training the set of positional embeddings leads to rich low-dimensional positional embeddings that outperform other types of positional embeddings, e.g., high-dimensional hand-designed Fourier embeddings, for various downstream tasks.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, or a Google JAX framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more data processing apparatus for using a neural network to generate a network output that characterizes an entity, the method comprising:
obtaining a representation of the entity as a set of data element embeddings;
obtaining a set of latent embeddings; and
processing: (i) the set of data element embeddings, and (ii) the set of latent embeddings, using the neural network to generate the network output characterizing the entity,
wherein the neural network comprises a sequence of neural network blocks comprising:
(i) one or more local cross-attention blocks, and (ii) an output block,
wherein each local cross-attention block performs operations comprising:
determining a partition of the set of latent embeddings into a plurality of proper subsets of the set of latent embeddings;
determining a partition of the set of data element embeddings into a plurality of proper subsets of the set of data element embeddings;
identifying, for each proper subset of latent embeddings, a corresponding proper subset of the data element embeddings; and
updating each proper subset of the set of latent embeddings using attention over only the corresponding proper subset of the set of data element embeddings; and
wherein the output block performs operations comprising:
after the set latent embeddings are updated using the one or more cross-attention blocks, processing one or more latent embeddings from the set of latent embeddings to generate the network output characterizing the entity.

2. The method of claim 1, wherein the neural network further comprises one or more self-attention blocks, wherein each self-attention block performs operations comprising:
updating the set of latent embeddings using attention over the set of latent embeddings.

3. The method of claim 1, wherein the neural network further comprises one or more global cross-attention blocks, wherein each global cross-attention block performs operations comprising:
updating the set of latent embeddings using attention over the set of data element embeddings.

4. The method of claim 1, wherein for each local cross-attention block, the set of latent embeddings is partitioned into a same number of proper subsets as the set of data element embeddings.

5. The method of claim 1, wherein for each local cross-attention block, each proper subset of the latent embeddings corresponds to a different proper subset of the data element embeddings.

6. The method of claim 1, wherein the neural network comprises a locality-reducing sequence of local cross-attention blocks, wherein for each local cross-attention block after a first local cross-attention block in the locality-reducing sequence of local cross-attention blocks:
the local cross-attention block partitions the set of data element embeddings into a smaller number of proper subsets than a preceding local cross-attention block in the locality-reducing sequence of local cross-attention blocks.

7. The method of claim 6, wherein the neural network comprises a locality-increasing sequence of local cross-attention blocks, wherein for each local cross-attention block after a first local cross-attention block in the locality-increasing sequence of local cross-attention blocks:
the local cross-attention block partitions the set of data element embeddings into a greater number of proper subsets than a preceding local cross-attention block in the locality-increasing sequence of local cross-attention blocks.

8. The method of claim 7, wherein the locality-reducing sequence of local cross-attention blocks precedes the locality-increasing sequence of local cross-attention blocks in the neural network.

9. The method of claim 8, wherein the neural network comprises one or more global cross-attention blocks between the locality-reducing sequence of local cross-attention blocks and the locality-increasing sequence of local cross-attention blocks.

10. The method of claim 1, wherein a number of latent embeddings in the set of latent embeddings is less than a number of data element embeddings in the set of data element embeddings.

11. The method of claim 1, wherein a number of latent embeddings in the set of latent embeddings is predefined and independent of a number of data element embeddings in the set of data element embeddings.

12. The method of claim 1, wherein the neural network comprises a plurality of local cross-attention blocks and a plurality of self-attention blocks, and wherein the plurality of local cross-attention blocks and the plurality of self-attention blocks are interleaved.

13. The method of claim 1, wherein for each local cross-attention block, updating each proper subset of the latent embeddings comprises, for each latent embedding in the proper subset of the latent embeddings:
determining, for each data element embedding in the corresponding proper subset of the data element embeddings, a respective attention weight for the data element embedding based on: (i) the data element embedding, and (ii) the latent embedding; and
updating the latent embedding using: (i) the attention weights, and (ii) the corresponding proper subset of the data element embeddings.

14. The method of claim 1, further comprising:
obtaining a set of positional embeddings, wherein each positional embedding represents a position of a corresponding data element embedding in the representation of the entity;
wherein processing: (i) the set of data element embeddings, and (ii) the set of latent embeddings, using the neural network comprises:
updating each data element embedding using a respective positional embedding representing the position of the data element embedding.

15. The method of claim 14, further comprising masking a portion of the representation of the entity before the representation of the entity is provided to the neural network, wherein the network output comprises a reconstruction of the masked portion of the representation of the entity.

16. The method of claim 15, further comprising:
determining gradients of an error in the reconstruction of the masked portion of the representation of the entity; and
updating the set of positional embeddings using the gradients of the error in the reconstruction of the masked portion of the representation of the entity.

17. The method of claim 1, wherein the set of data element embeddings comprises at least one million data element embeddings.

18.-26. (canceled)

27. A system comprising:
one or more computers; and
one or more storage devices communicatively coupled to the one or more computers, wherein the one or more storage devices store instructions that, when executed by the one or more computers, cause the one or more computers to perform operations for using a neural network to generate a network output that characterizes an entity, the operations comprising:
obtaining a representation of the entity as a set of data element embeddings;
obtaining a set of latent embeddings; and
processing: (i) the set of data element embeddings, and (ii) the set of latent embeddings, using the neural network to generate the network output characterizing the entity,
wherein the neural network comprises a sequence of neural network blocks comprising:
(i) one or more local cross-attention blocks, and (ii) an output block,
wherein each local cross-attention block performs operations comprising:
determining a partition of the set of latent embeddings into a plurality of proper subsets of the set of latent embeddings;
determining a partition of the set of data element embeddings into a plurality of proper subsets of the set of data element embeddings;
identifying, for each proper subset of latent embeddings, a corresponding proper subset of the data element embeddings; and
updating each proper subset of the set of latent embeddings using attention over only the corresponding proper subset of the set of data element embeddings; and
wherein the output block performs operations comprising:
after the set latent embeddings are updated using the one or more cross-attention blocks, processing one or more latent embeddings from the set of latent embeddings to generate the network output characterizing the entity.

28. One or more non-transitory computer storage media storing instructions that when executed by one or more computers cause the one or more computers to perform operations for using a neural network to generate a network output that characterizes an entity, the operations comprising:
obtaining a representation of the entity as a set of data element embeddings;
obtaining a set of latent embeddings; and
processing: (i) the set of data element embeddings, and (ii) the set of latent embeddings. using the neural network to generate the network output characterizing the entity,
wherein the neural network comprises a sequence of neural network blocks comprising:
(i) one or more local cross-attention blocks, and (ii) an output block,
wherein each local cross-attention block performs operations comprising:
determining a partition of the set of latent embeddings into a plurality of proper subsets of the set of latent embeddings;
determining a partition of the set of data element embeddings into a plurality of proper subsets of the set of data element embeddings;
identifying, for each proper subset of latent embeddings, a corresponding proper subset of the data element embeddings; and
updating each proper subset of the set of latent embeddings using attention over only the corresponding proper subset of the set of data element embeddings; and
wherein the output block performs operations comprising:
after the set latent embeddings are updated using the one or more cross-attention blocks, processing one or more latent embeddings from the set of latent embeddings to generate the network output characterizing the entity.
